(19) United States
(12) Patent Application Publication
(10) Pub. No.: US 2018/0087171 A1
(43) Pub. Date: Mar. 29, 2018

(54) ELECTRICAL CONNECTOR ELECTROPLATING PROCESS

(71) Applicant: DONGGUAN C.C.P.CONTACT PROBES CO., LTD., Dongguan (CN)

(72) Inventors: Tsung-Ming Tsai, Taipei City (TW); Yong-Ping Lee, New Taipei City (TW); Chen-Yu Chung, Kaohsiung City (TW); Tang-Hsing Ho, New Taipei City (TW)

(21) Appl. No.: 15/712,160

(22) Filed: Sep. 22, 2017

(30) Foreign Application Priority Data
Sep. 27, 2016 (CN) 201610860119.5

(51) Int. Cl. C25D 5/10; H01R 13/03; H01R 43/00; H01R 43/16; C25D 3/46; C25D 3/48; C25D 3/50; C25D 5/34; C25D 5/50

(52) U.S. Cl. CPC C25D 5/10; H01R 13/03; H01R 43/005; H01R 43/16; C25D 5/50; C25D 3/48; C25D 3/50; C25D 5/34; C25D 3/46

(57) ABSTRACT

An electrical connector electroplating process includes: performing a pre-treatment of an electrical connector to remove grease; performing an activation treatment of the electrical connector to activate an oxide film on a surface of the electrical connector; plating a layer of bottom coating on the surface of the electrical connector; plating a layer of silver film coating on a surface of the bottom coating; plating a layer of gold film coating on a surface of the silver film coating; plating a layer of platinum or rhodium film coating on a surface of the gold film coating; performing a post-treatment including surface pore sealing, water washing, and baking/drying of a surface of the platinum or rhodium film coating.

### FIELD OF THE INVENTION

The present invention relates to the technical field of electroplating, and more particularly an electrical connector electroplating process.

### BACKGROUND OF THE INVENTION

### 1. Description of the Related Art

As science and technology advance, people have an increasingly higher requirement on the appearance of electronic products as well as thinner and lighter design of the electronic products and smaller electronic components. Since the size of the electronic components becomes smaller and smaller, there are issues of producing an electrolysis of an electrical connector very easily during an electrical conduction process, and such issues include electrolytic corrosion or sweat corrosion which affect the service life of the electrical connector significantly.

Therefore, finding a way of extending the electrolysis resisting time of the electrical connectors effectively to improve the service life of the electrical connector demands immediate attentions and feasible solutions.

### 2. Summary of the Invention

In view of the aforementioned drawbacks of the conventional electrical connectors, it is a primary objective of the present invention to provide an electrical connector electroplating process that can overcome the issues of easy electrolysis and short service life of the electrical connectors effectively.

To achieve the aforementioned and other objectives, the present invention provides an electrical connector electroplating process comprising the following steps:

S1: Perform a pre-treatment of an electrical connector to remove grease.

S2: Perform an activation treatment of the electrical connector to activate an oxide film on a surface of the electrical connector.

S3: Plate a layer of bottom coating on the surface of the electrical connector.

S4: Plate a layer of silver film coating on a surface of the bottom coating.

S5: Plate a layer of gold film coating on a surface of the silver film coating.

S6: Plate a layer of platinum or rhodium film coating on a surface of the gold film coating.

S7: Perform a post-treatment including surface pore sealing, water washing and baking/drying of the surface of the platinum or rhodium film coating.

Preferably, the step S1 specifically comprises the following steps:

S11: Perform an ultrasonic oscillation for a degreasing solution and an organic oil removal solution of the electrical connector, wherein the processing time is 10-20 minutes.

S12: Wash the electrical connector by pure water at room temperature until the water becomes colorless and transparent.

S13: Perform an ultrasonic oscillation for an oil removal solution of the electrical connector, wherein the concentration of the oil removal solution is 50-80 g/L, the processing time is 10-20 minutes, the processing temperature is 40-60° C., and the operation of the step S12 is repeated.

Preferably, the step S2 specifically comprises the following steps:

S21: Perform an ultrasonic oscillation for an organic weak acid of the electrical connector, wherein the concentration of the organic weak acid is 10-50 g/L, and the processing time is 10-20 minutes.

S22: Wash the electrical connector by pure water at room temperature until salts on the surface of the electrical connector are removed completely/

S23: Perform an ultrasonic oscillation for an activated acid of the electrical connector, wherein the concentration of the activated acid is 10-20%, and the processing time is 10-20 minutes.

S24: Wash the electrical connector by pure water at room temperature until the surface of the electrical connector is cleaned.

Preferably, the step S6 specifically comprises the following steps:

S61: Perform a platinum or rhodium plating of a surface of the electrical connector by a manual shaking or barrel plating method, wherein the plating time is 2-50 minutes, the pH value of the platinum or rhodium plating solution <3, the plating temperature is 30-60° C., and the current density is 0.1-1.0 A/dm².

S62: Sample and test a film thickness to ensure that the thickness of the platinum or rhodium film coating is 2-50 micro inch.

S63: Wash the electrical connector by pure water at room temperature until the platinum or rhodium film coating on the surface of the platinum or rhodium film coating is cleaned.

Preferably, the step S7 specifically comprises the following steps:

S71: Perform a surface micropore sealing process of the platinum or rhodium film coating by a pore sealing agent, wherein the processing time is 1-20 minutes.

S72: Wash the electrical connector by pure water until the surface of the electrical connector is cleaned.

S73: Perform dehydration by a centrifuge or dehydrator until the gauze has no obvious water droplet.

S74: Heat and dry a surface of the plating part by an air blower at 50-15° C., wherein the air blowing time is 6-15 minutes.

S75: Bake/dry the surface of the plating part in an oven at 100-150° C., wherein the baking/drying time is 10-60 minutes.

Preferably, the bottom coating is a copper film coating, and the electrical connector electroplating process further comprises the following step between the steps S3 and S4:

S3A: Plate a pre-plated silver film coating on the surface of the bottom coating; and the step 4 specifically plates a layer of silver film coating on the surface of the pre-plated silver film coating.

Preferably, the step S3 specifically comprises the following steps:

S31: Perform a copper plating of the surface of the electrical connector by a manual shaking or barrel plating method, wherein the plating time is 2-6 minutes, the pH value of the copper plating solution is 7.8-11.0, the plating temperature is 40-65° C., the current density is 0.2-0.8 A/dm², and the thickness of the copper film coating is 1-20 micro inch.

S32: Wash the electrical connector by pure water at room temperature until the copper film coating on the surface of the electrical connector is cleaned.

S33: Perform an ultrasonic oscillation for an activated acid of the copper film coating, wherein the concentration of the activated acid is 10-20%, and the processing time is 1-4 minutes.

S34: Wash the electrical connector by pure water at room temperature until the copper film coating on the surface of the electrical connector is cleaned.

Preferably, the step S32 specifically comprises the steps of soaking and washing the copper film coating on the surface of the electrical connector by pure water at room temperature, covering the electrical connector by some of the pure water remained after washing, pouring out the remaining pure water, and then adding new pure water, wherein the step S32 is repeated for 3-5 times.

Preferably, the step S3A specifically comprises the following steps:

S3A1: Perform a pre-plated silver plating of the surface of the electrical connector by a manual shaking or barrel plating method, wherein the plating time is 2-25 minutes, the plating temperature is 15-25° C., and the current density is 0-1.0 A/dm².

S3A2: Sample and test a film thickness to ensure that the thickness of the pre-plated silver film coating is 0-20 micro inch.

Preferably, the step S4 specifically comprises the following steps:

S41: Perform a silver plating of the surface of the electrical connector by a manual shaking or barrel plating method, wherein the plating time is 2-25 minutes, the plating temperature is 15-25° C., and the current density is 0-1.0 A/dm.

S42: Sample and test a film thickness to ensure that the thickness of the silver film coating is 2-300 micro inch.

S43: Wash the electrical connector by pure water at room temperature until the silver film coating on the surface of the electrical connector is cleaned is cleaned.

Preferably, the step S5 specifically comprises the following steps:

S51: Perform a gold plating of the surface of the electrical connector by a manual shaking or barrel plating method, wherein the plating time is 2-100 minutes, the pH value of the gold plating solution is 3.0-6.5, the plating temperature is 20-70° C., the current density is 0.1-1.0 A/dm², and the Baume degree is 8-20° Be.

S52: Sample and test a film thickness to ensure that the thickness of the gold film coating is 2-200 micro inch.

S53: Wash the electrical connector by pure water at room temperature until the gold film coating on the surface of the electrical connector is cleaned.

Preferably, the bottom coating is a palladium film coating, and the step S3 specifically comprises the following steps:

S31: Perform a palladium plating of the surface of the electrical connector by a manual shaking or barrel plating method, wherein the plating time is 2-20 minutes, the pH value of the palladium plating solution is 4-13.0, the plating temperature is 30-70° C., the current density is 0.15-0.8 A/dm², and the thickness of the palladium film coating is 1-20 micro inch.

S32: Wash the electrical connector by pure water at room temperature until the palladium film coating on the surface of the electrical connector is cleaned.

Preferably, the step S32 specifically comprises the steps of: soaking and washing the palladium film coating on the surface of the electrical connector by pure water at room temperature; covering the electrical connector by some of the pure water remained after washing; pouring out the remaining pure water; and then adding new pure water, wherein the step S32 is repeated for 3-5 times.

Preferably, the step S4 specifically comprises the following steps:

S41: Perform a silver plating of the surface of the electrical connector by a manual shaking or barrel plating method, wherein the plating time is 2-25 minutes, the plating temperature is 15-25° C., and the current density is 0-1.0 A/dm².

S42: Sample and test a film thickness to ensure that the thickness of the silver film coating is 2-300 micro inch.

S43: Wash the electrical connector by pure water at room temperature until the silver film coating on the surface of the electrical connector is cleaned.

Preferably, the step S5 specifically comprises the following steps:

S51: Perform a gold plating of the surface of the electrical connector by a manual shaking or barrel plating method, wherein the plating time is 2-100 minutes, the pH value of the gold plating solution is 3.0-6.5, the plating temperature is 20-70° C., the current density is 0.1-1.0 A/dm², and the Baume degree is 8-20° Be.

S52: Sample and test a film thickness to ensure that the thickness of the gold film coating is 2-200 micro inch.

S53: Wash the electrical connector by pure water at room temperature until the gold film coating on the surface of the electrical connector is cleaned.

In summation, the electrical connector electroplating process of the present invention comprises the steps of: performing a pre-treatment of an electrical connector to remove grease; performing an activation treatment of the electrical connector to activate an oxide film on a surface of the electrical connector; plating a layer of bottom coating on the surface of the electrical connector; plating a layer of silver film coating on a surface of the bottom coating; plating a layer of gold film coating on a surface of the silver film coating; plating a layer of platinum or rhodium film coating on a surface of the gold film coating; performing a post-treatment including surface pore sealing, water washing, and baking/drying of a surface of the platinum or rhodium film coating. The plating process uses a combination of non-active metal coatings which are not allergic to human bodies to achieve the effects of satisfying related environmental testing for the electrolytic corrosion resistance and sweat corrosion resistance of the electrical connector. The process also has the advantages of low material cost, easy to be executed, and low production cost; in the meantime, the present methods create products that meet the high quality standards of the electrical connector products.

### BRIEF DESCRIPTION OF THE DRAWINGS

The above and other objects, features and advantages of this disclosure will become apparent from the following detailed description taken with the accompanying drawings. It is noteworthy that the drawings are provided for the purpose of illustrating the invention and other drawings may be obtained without any creative labor by persons having ordinary skill in the art.

FIG. 1 is a flow chart of an electrical connector electroplating process in accordance with a first preferred embodiment of the present invention;

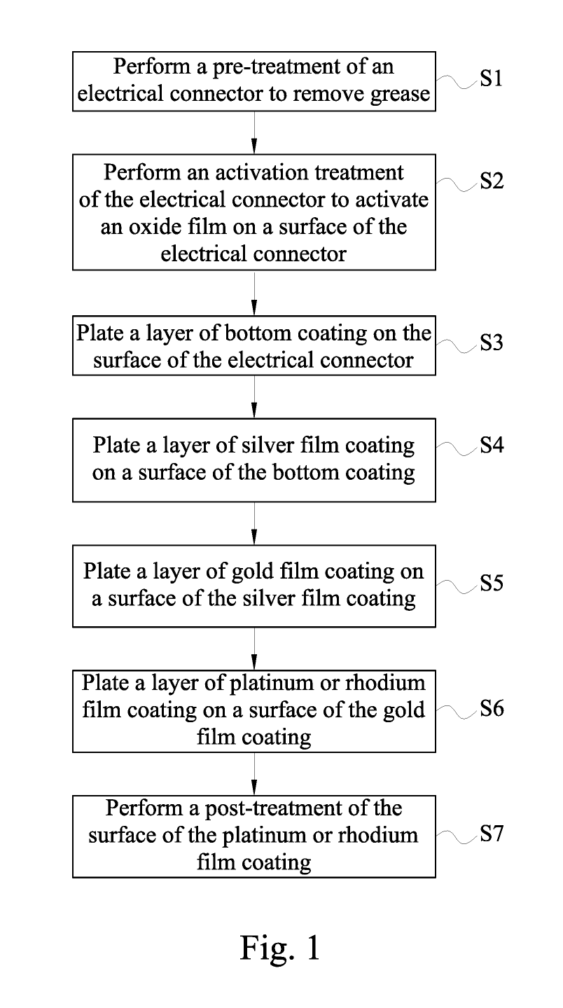

FIG. 2 is a flow chart of an electrical connector electroplating process in accordance with a second preferred embodiment of the present invention; and

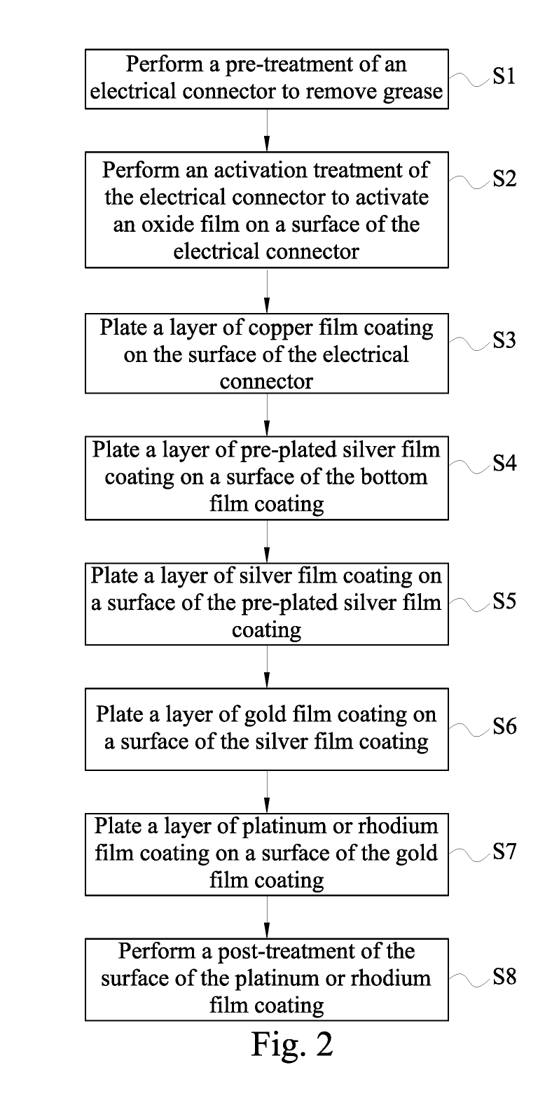

FIG. 3 is a flow chart of an electrical connector electroplating process in accordance with a third preferred embodiment of the present invention.

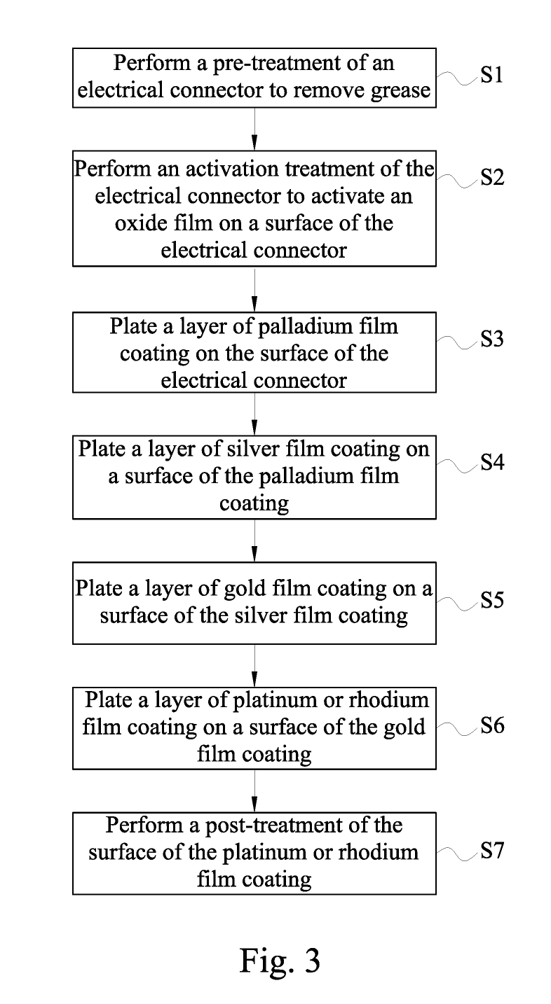

The present invention discloses an electrical connector electroplating process capable of improving the corrosion resistance and the life service of the electrical connector significantly.

### DESCRIPTION OF THE PREFERRED EMBODIMENTS

The electrical connector electroplating process in accordance with a preferred embodiment of the present invention comprises the following steps:

S1: Perform a pre-treatment of an electrical connector to remove grease and ensure a clean surface of the electrical connector to facilitate the following plating processes.

S2: Perform an activation treatment of the electrical connector to activate an oxide film on a surface of the electrical connector, so as to facilitate the work of providing a surface adhesion of the electric connector.

S3: Plate a layer of bottom coating on the surface of the electrical connector.

S4: Plate a layer of silver film coating on a surface of the bottom coating to prevent the bottom coating from being oxidized and improve the corrosion resistance of the surface of the electrical connector effectively, wherein the silver plating solution used by the present invention is an electrolyte containing silver metal with a low material cost for lowering the production cost.

S5: Plate a layer of gold film coating on a surface of the silver film coating to improve the adhesion between coatings and prevent the platinum or rhodium plating solution used in the following platinum or rhodium plating process from corroding the coatings, so as to improve the corrosion resistance of the surface of the electrical connector, wherein the gold plating solution of the present invention is an electrolyte containing gold metal with a low material cost for lowering the production cost.

S6: Plate a layer of platinum or rhodium film coating on a surface of the gold film coating. Platinum or rhodium features a low resistance value, a small power generated heat, and a stable electric signal transmission, and the platinum or rhodium film coating is substantially silver in color which the same color of a conventional regular electrical connector and capable of improve the appearance, quality, and add-on value of the product. In addition, platinum or rhodium has a lower metal activity which can effectively improve the wear-resistance and electrolytic resistance, and the service life of the electrical connector which is plugged, unplugged and conducted frequently. The platinum or rhodium plating solution used in the present invention is an electrolyte containing rare metal platinum or rhodium with a low material cost for lowering the production cost.

S7: Perform a post-treatment including surface pore sealing, water washing and baking/drying of the surface of the platinum or rhodium film coating to improve the corrosion resistance and service life of the plated product.

In the plating process in accordance with the preferred embodiment of the present invention, the step S1 comprises the following steps:

S11: Perform an ultrasonic oscillation for a degreasing solution and an organic oil removal solution of the electrical connector, wherein the processing time is 10-20 minutes.

S12: Wash the electrical connector by pure water at room temperature until the water becomes colorless and transparent.

S13: Perform an ultrasonic oscillation for an oil removal solution of the electrical connector, wherein the concentration of the oil removal solution is 50-80 g/L, the processing time is 10-20 minutes, the processing temperature is 40-60° C., wherein the operation of the step S12 is repeated.

In the plating process in accordance with the preferred embodiment of the present invention, the step S2 specifically comprises the following steps:

S21: Perform an ultrasonic oscillation for an organic weak acid of the electrical connector, wherein the concentration of the organic weak acid is 10-50 g/L, and the processing time is 10-20 minutes.

S22: Wash the electrical connector by pure water at room temperature until salts on the surface of the electrical connector are removed completely.

S23: Perform an ultrasonic oscillation for an activated acid of the electrical connector, wherein the concentration of the activated acid is 10-20%, and the processing time is 10-20 minutes.

S24: Wash the electrical connector by pure water at room temperature until the surface of the electrical connector is cleaned.

In the plating process in accordance with the preferred embodiment of the invention, the step S6 comprises the following steps:

S61: Perform a platinum or rhodium plating of a surface of the electrical connector by a manual shaking or barrel plating method, wherein the plating time is 2-50 minutes, the pH value of the platinum or rhodium plating solution <3, the plating temperature is 30-60° C., and the current density is 0.1-1.0 A/dm².

S62: Sample and test a film thickness to ensure that the thickness of the platinum or rhodium film coating is 2-50 micro inch.

S63: Wash the electrical connector by pure water at room temperature until the platinum or rhodium film coating on the surface of the platinum or rhodium film coating is cleaned.

In the plating process in accordance with the preferred embodiment of the present invention, the step S7 comprises the following steps:

S71: Perform a surface micropore sealing process of the platinum or rhodium film coating by a pore sealing agent, wherein the processing time is 1-20 minutes.

S72: Wash the electrical connector by pure water until the surface of the electrical connector is cleaned.

S73: Perform dehydration by a centrifuge or dehydrator until the gauze has no obvious water droplet.

S74: Heat and dry a surface of the plating part by an air blower at 50-15° C., wherein the air blowing time is 6-15 minutes.

S75: Bake/dry the surface of the plating part in an oven at 100-150° C., wherein the baking/drying time is 10-60 minutes.

Preferably, the quantity of meshes of the gauze is equal to 100-150 meshes, and it is noteworthy that the gauze is mainly provided for separating water from the electrical connector during the centrifuge and dehydration process. Of course, the invention is not limited to the use of the gauze only, but any other tools capable of separating water from the electrical connector may be used as well.

In another preferred embodiment of the present invention, the bottom coating is a copper film coating. The process of the invention further comprises the following steps between the steps S3 and S4:

S3A: Plate a pre-plated silver film coating on the surface of the bottom coating.

S4: Plate a layer of silver film coating on the surface of the pre-plated silver film coating.

The electrical connector electroplating process in accordance with the preferred embodiment of the present invention comprises the following steps:

S1: Perform a pre-treatment of an electrical connector to remove grease.

S2: Perform an activation treatment of the electrical connector to activate an oxide film on a surface of the electrical connector.

S3: Plate a layer of bottom coating on the surface of the electrical connector.

S3A: Plate a pre-plated silver film coating on the surface of the bottom coating.

S4: Plate a layer of silver film coating on a surface of the bottom coating.

S5: Plate a layer of gold film coating on a surface of the silver film coating.

S6: Plate a layer of platinum or rhodium film coating on a surface of the gold film coating.

S7: Perform a post-treatment including surface pore sealing, water washing and baking/drying of the surface of the platinum or rhodium film coating.

In the step S3, most of the conventional electrical connectors are made of a copper substrate, and copper is plated on the surface of the electrical connector to form a copper film coating to effectively prevent the substrate from being oxidized in a humid environment and prevent the conductivity of the probe from being affected by the humid environment. Further, small protrusions or recesses are formed on the electrical connector easily during the manufacturing process, and the plated copper is helpful to ensure that the surface of the substrate is flat and even to improve the quality of the product. Further, the copper film coating has a good adhesion with the surface of the electrical connector made of copper, so that the copper film coating can be attached very well on the surface of the probe to form a protective layer. Finally, copper is plated onto the substrate surface of the electrical connector to effectively prevent the surface of the electrical connector from being reacted with the silver of the silver plating solution during the following pre-plated silver plating process to ruin the conductivity of the probe, and effectively prevent the loss of probe substrate. Wherein, the copper plating solution of the present invention is an electrolyte containing copper metal with a low material cost for lowering the production cost.

In the step S3A, the pre-plated silver film coating is provided for effectively preventing the copper base layer from being oxidized and improving the corrosion resistance of the surface of the electrical connector. Finally, the pre-plated silver plating pre-plated on the copper coating of the electrical connector is provided for effectively preventing the silver plating solution from corroding the substrate during the following silver plating process. Wherein, the silver plating solution of the present invention is an electrolyte containing metal silver with a low material cost for lowering the production cost.

In the foregoing preferred embodiments of the present invention, the bottom coating is a copper film coating, and the step S3 specifically comprises the following steps:

S31: Perform a copper plating of the surface of the electrical connector by a manual shaking or barrel plating method, wherein the plating time is 2-6 minutes, the pH value of the copper plating solution is 7.8-11.0, the plating temperature is 40-65° C., the current density is 0.2-0.8 A/dm², and the thickness of the copper film coating is 1-20 micro inch.

S32: Wash the electrical connector by pure water at room temperature until the copper film coating on the surface of the electrical connector is cleaned.

S33: Perform an ultrasonic oscillation for an activated acid of the copper film coating, wherein the concentration of the activated acid is 10-20%, and the processing time is 1-4 minutes.

S34: Wash the electrical connector by pure water at room temperature until the copper film coating on the surface of the electrical connector is cleaned.

In the foregoing preferred embodiments of the present invention, the bottom coating is a copper film coating, and the step S32 specifically comprises the steps of: soaking and washing the copper film coating on the surface of the electrical connector by pure water at room temperature; covering the electrical connector by some of the pure water remained after washing; pouring out the remaining pure water, and adding new pure water, wherein the step S32 is repeated for 3-5 times.

In the foregoing preferred embodiments of the present invention, the bottom coating is a copper film coating, and the step S3A specifically comprises the following steps:

S3A1: Perform a pre-plated silver plating of the surface of the electrical connector by a manual shaking or barrel plating method, wherein the plating time is 2-25 minutes, the plating temperature is 15-25° C., and the current density is 0-1.0 A/dm².

S3A2: Sample and test a film thickness to ensure that the thickness of the pre-plated silver film coating is 0-20 micro inch.

In the foregoing preferred embodiments of the present invention, the bottom coating is a copper film coating, and the step S4 specifically comprises the following steps:

S41: Perform a silver plating of the surface of the electrical connector by a manual shaking or barrel plating method, wherein the plating time is 2-25 minutes, the plating temperature is 15-25° C., and the current density is 0-1.0 A/dm².

S42: Sample and test a film thickness to ensure that the thickness of the silver film coating is 2-300 micro inch.

S43: Wash the electrical connector by pure water at room temperature until the silver film coating on the surface of the electrical connector is cleaned is cleaned.

In the foregoing preferred embodiments of the present invention, the bottom coating is a copper film coating, and the step S5 specifically comprises the following steps:

S51: Perform a gold plating of the surface of the electrical connector by a manual shaking or barrel plating method, wherein the plating time is 2-100 minutes, the pH value of the gold plating solution is 3.0-6.5, the plating temperature is 20-70° C., the current density is 0.1-1.0 A/dm², and the Baume degree is 8-20° Be.

S52: Sample and test a film thickness to ensure that the thickness of the gold film coating is 2-200 micro inch.

S53: Wash the electrical connector by pure water at room temperature until the gold film coating on the surface of the electrical connector is cleaned.

The third preferred embodiment of the present invention is based on the foregoing preferred embodiments, and the bottom coating is a palladium film coating, and electrical connector electroplating process of this preferred embodiment comprises the following steps:

S1: Perform a pre-treatment of an electrical connector to remove grease.

S2: Perform an activation treatment of the electrical connector to activate an oxide film on a surface of the electrical connector.

S3: Plate a layer of palladium coating on the surface of the electrical connector.

S3A: Plate a pre-plated silver film coating on the surface of the bottom coating.

S4: Plate a layer of silver film coating on a surface of the palladium coating.

S5: Plate a layer of gold film coating on a surface of the silver film coating.

S6: Plate a layer of platinum or rhodium film coating on a surface of the gold film coating.

S7: Perform a post-treatment including surface pore sealing, water washing and baking/drying of the surface of the platinum or rhodium film coating.

In the step S3, most of the conventional electrical connectors are made of a copper substrate, and palladium is plated on the surface of the electrical connector to form a palladium film coating to effectively prevent the diffusion of copper ions of the substrate and prevent the conductively of the electrical connector from being affected. Further, the palladium film coating has a good adhesion with the surface of the electrical connector made of copper, so that the palladium film coating can be attached very well on the surface of the probe to form a protective layer. Finally, palladium is plated onto the substrate surface of the electrical connector to effectively prevent the substrate from being corroded by the silver plating solution in the silver plating process and prevent the conductivity of the electrical connector from being affected adversely to avoid the loss of probe substrate. Wherein, the palladium plating solution used in the present invention is an electrolyte containing palladium metal with a low material cost for lowering the production cost.

Specifically, the step S3 comprises the following steps:

S31: Perform a palladium plating of the surface of the electrical connector by a manual shaking or barrel plating method, wherein the plating time is 2-50 minutes, the pH value of the palladium plating solution is 4-13.0, the plating temperature is 30-70° C., the current density is 0.15-0.8 A/dm², and the thickness of the palladium film coating is 1-20 micro inch.

S32: Wash the electrical connector by pure water at room temperature until the palladium film coating on the surface of the electrical connector is cleaned.

Based on the foregoing preferred embodiment, the step of S32 specifically comprises the steps of: soaking and washing the palladium film coating on the surface of the electrical connector by pure water at room temperature; covering the electrical connector by some of the pure water remained after washing; pouring out the remaining pure water; and then adding new pure water, wherein the step S32 is repeated for 3-5 times.

Based on the foregoing preferred embodiments, the step S4 comprises the following steps:

S41: Perform a silver plating of the surface of the electrical connector by a manual shaking or barrel plating method, wherein the plating time is 2-25 minutes, the plating temperature is 15-25° C., and the current density is 0-1.0 A/dm².

S42: Sample and test a film thickness to ensure that the thickness of the silver film coating is 2-300 micro inch.

S43: Wash the electrical connector by pure water at room temperature until the silver film coating on the surface of the electrical connector is cleaned.

Based on the foregoing preferred embodiment, the step S5 specifically comprises the following steps:

S51: Perform a gold plating of the surface of the electrical connector by a manual shaking or barrel plating method, wherein the plating time is 2-100 minutes, the pH value of the gold plating solution is 3.0-6.5, the plating temperature is 20-70° C., the current density is 0.1-1.0 A/dm², and the Baume degree is 8-20° Be.

S52: Sample and test a film thickness to ensure that the thickness of the gold film coating is 2-200 micro inch.

S53: Wash the electrical connector by pure water at room temperature until the gold film coating on the surface of the electrical connector is cleaned.

Of course, the bottom coating may be the coating made of a material as disclosed in the second and third preferred embodiments, but a copper-lead alloy coating or a nickel coating may also be used in this invention.

It is noteworthy that the electrolyte of the present invention includes but not limited to the copper plating solution, silver plating solution, gold plating solution, platinum or rhodium plating solution and palladium plating solution, and persons having ordinary skill in the art may use any other equivalent electrolyte as a plating solution for the same purpose.

The electrical connector electroplating process of the present invention uses a combination of non-active metal coatings which are not allergic to human bodies to achieve the effects of satisfying related environmental testing for the electrolytic corrosion resistance and sweat corrosion resistance of the electrical connector. The process also has the advantages of low material cost, manufacturing easy, and production cost meets the high requirements for the appearance and quality of the electrical connector products.

Each embodiment of this specification is described progressively, and the key point of the description of each embodiment resides on the difference with other preferred embodiments, so that the same or similar portions of the embodiments may be cross referenced.

What is claimed is:

1. An electrical connector electroplating process, comprising the steps of:
S1: performing a pre-treatment of an electrical connector to remove grease;
S2: performing an activation treatment of the electrical connector to activate an oxide film on a surface of the electrical connector;
S3: plating a layer of bottom coating on the surface of the electrical connector;
S4: plating a layer of silver film coating on a surface of the bottom coating;
S5: plating a layer of gold film coating on a surface of the silver film coating;
S6: plating a layer of platinum or rhodium film coating on a surface of the gold film coating; and
S7: performing a post-treatment including surface pore sealing, water washing and baking/drying of the surface of the platinum or rhodium film coating.

2. The electrical connector electroplating process according to claim 1, wherein the step S1 specifically comprises the steps of:
S11: performing an ultrasonic oscillation for a degreasing solution and an organic oil removal solution of the electrical connector, wherein the processing time is 10-20 minutes;
S12: washing the electrical connector by pure water at room temperature until the water becomes colorless and transparent; and
S13: performing an ultrasonic oscillation for an oil removal solution of the electrical connector, wherein the concentration of the oil removal solution is 50-80 g/L, the processing time is 10-20 minutes, the processing temperature is 40-60° C., and the operation of the step S12 is repeated.

3. The electrical connector electroplating process according to claim 1, wherein the step S2 specifically comprises the steps of:
S21: performing an ultrasonic oscillation for an organic weak acid of the electrical connector, wherein the concentration of the organic weak acid is 10-50 g/L, and the processing time is 10-20 minutes;
S22: washing the electrical connector by pure water at room temperature until salts on the surface of the electrical connector are removed completely;
S23: performing an ultrasonic oscillation for an activated acid of the electrical connector, wherein the concentration of the activated acid is 10-20%, and the processing time is 10-20 minutes; and
S24: washing the electrical connector by pure water at room temperature until the surface of the electrical connector is cleaned.

4. The electrical connector electroplating process according to claim 1, wherein the step S6 specifically comprises the steps of:
S61: performing a platinum or rhodium plating of a surface of the electrical connector by a manual shaking or barrel plating method, wherein the plating time is 2-50 minutes, the pH value of the platinum or rhodium plating solution <3, the plating temperature is 30-60° C., and the current density is 0.1-1.0 A/dm²;
S62: sampling and testing a film thickness to ensure that the thickness of the platinum or rhodium film coating is 2-50 micro inch; and
S63: washing the electrical connector by pure water at room temperature until the platinum or rhodium film coating on the surface of the platinum or rhodium film coating is cleaned.

5. The electrical connector electroplating process according to claim 1, wherein the step S7 specifically comprises the steps of:
S71: performing a surface micropore sealing process of the platinum or rhodium film coating by a pore sealing agent, wherein the processing time is 1-20 minutes;
S72: washing the electrical connector by pure water until the surface of the electrical connector is cleaned;
S73: performing dehydration by a centrifuge or dehydrator until the gauze has no obvious water droplet;
S74: heating and drying a surface of the plating part by an air blower at 50-15° C., wherein the air blowing time is 6-15 minutes; and
S75: baking/drying the surface of the plating part in an oven at 100-150° C., wherein the baking/drying time is 10-60 minutes.

6. The electrical connector electroplating process according to claim 1, wherein the bottom coating is a copper film coating, and between the steps S3 and S4, the electrical connector electroplating process further comprises the step of S3A: plating a pre-plated silver film coating on the surface of the bottom coating; and plating a layer of silver film coating on the surface of the pre-plated silver film coating in the step S4.

7. The electrical connector electroplating process according to claim 6, wherein the step S3 specifically comprises the steps of:
S31: performing a copper plating of the surface of the electrical connector by a manual shaking or barrel plating method, wherein the plating time is 2-6 minutes, the pH value of the copper plating solution is 7.8-11.0, the plating temperature is 40-65° C., the current density is 0.2-0.8 A/dm², and the thickness of the copper film coating is 1-20 micro inch;
S32: washing the electrical connector by pure water at room temperature until the copper film coating on the surface of the electrical connector is cleaned;
S33: performing an ultrasonic oscillation for an activated acid of the copper film coating, wherein the concentration of the activated acid is 10-20%, and the processing time is 1-4 minutes; and
S34: washing the electrical connector by pure water at room temperature until the copper film coating on the surface of the electrical connector is cleaned.

8. The electrical connector electroplating process according to claim 6, wherein the step S32 specifically comprises the steps of soaking and washing the copper film coating on the surface of the electrical connector by pure water at room temperature, covering the electrical connector by some of the pure water remained after washing, pouring out the remaining pure water, and then adding new pure water, wherein the step S32 is repeated for 3-5 times.

9. The electrical connector electroplating process according to claim 6, wherein the step S3A specifically comprises the steps of:
S3A1: performing a pre-plated silver plating of the surface of the electrical connector by a manual shaking or barrel plating method, wherein the plating time is 2-25 minutes, the plating temperature is 15-25° C., and the current density is 0-1.0 A/dm²; and
S3A2: sampling and testing a film thickness to ensure that the thickness of the pre-plated silver film coating is 0-20 micro inch.

10. The electrical connector electroplating process according to claim 6, wherein the step S4 specifically comprises the steps of:
S41: performing a silver plating of the surface of the electrical connector by a manual shaking or barrel plating method, wherein the plating time is 2-25 minutes, the plating temperature is 15-25° C., and the current density is 0-1.0 A/dm²;
S42: sampling and testing a film thickness to ensure that the thickness of the silver film coating is 2-300 micro inch; and
S43: washing the electrical connector by pure water at room temperature until the silver film coating on the surface of the electrical connector is cleaned is cleaned.

11. The electrical connector electroplating process according to claim 6, wherein the step S5 specifically comprises the steps of:
S51: performing a gold plating of the surface of the electrical connector by a manual shaking or barrel plating method, wherein the plating time is 2-100 minutes, the pH value of the gold plating solution is 3.0-6.5, the plating temperature is 20-70° C., the current density is 0.1-1.0 A/dm², and the Baume degree is 8-20° Be;
S52: sampling and testing a film thickness to ensure that the thickness of the gold film coating is 2-200 micro inch; and
S53: washing the electrical connector by pure water at room temperature until the gold film coating on the surface of the electrical connector is cleaned.

12. The electrical connector electroplating process according to claim 1, wherein the bottom coating is a palladium film coating, and the step S3 specifically comprises the steps of:
S31: performing a palladium plating of the surface of the electrical connector by a manual shaking or barrel plating method, wherein the plating time is 2-50 minutes, the pH value of the palladium plating solution is 4-13.0, the plating temperature is 30-70° C., the current density is 0.15-0.8 A/dm², and the thickness of the palladium film coating is 1-20 micro inch; and
S32: washing the electrical connector by pure water at room temperature until the palladium film coating on the surface of the electrical connector is cleaned.

13. The electrical connector electroplating process according to claim 12, wherein the step S32 specifically comprises the steps of: soaking and washing the palladium film coating on the surface of the electrical connector by pure water at room temperature; covering the electrical connector by some of the pure water remained after washing; pouring out the remaining pure water; and then adding new pure water, wherein the step S32 is repeated for 3-5 times.

14. The electrical connector electroplating process according to claim 12, wherein the step S4 specifically comprises the steps of:
S41: performing a silver plating of the surface of the electrical connector by a manual shaking or barrel plating method, wherein the plating time is 2-25 minutes, the plating temperature is 15-25° C., and the current density is 0-1.0 A/dm²;
S42: sampling and testing a film thickness to ensure that the thickness of the silver film coating is 2-300 micro inch; and
S43: washing the electrical connector by pure water at room temperature until the silver film coating on the surface of the electrical connector is cleaned.

15. The electrical connector electroplating process according to claim 12, wherein the step S5 specifically comprises the steps of:
S51: performing a gold plating of the surface of the electrical connector by a manual shaking or barrel plating method, wherein the plating time is 2-100 minutes, the pH value of the gold plating solution is 3.0-6.5, the plating temperature is 20-70° C., the current density is 0.1-1.0 A/dm², and the Baume degree is 8-20° Be;
S52: sampling and testing a film thickness to ensure that the thickness of the gold film coating is 2-200 micro inch; and
S53: washing the electrical connector by pure water at room temperature until the gold film coating on the surface of the electrical connector is cleaned.
